(19) United States
(12) Patent Application Publication
(10) Pub. No.: US 2008/0291010 A1
(43) Pub. Date: Nov. 27, 2008

(54) MOTHER-DAUGHTER SECURITY ALARM SYSTEM WITH DIRECTION INDICATION MEANS

(75) Inventor: Wen-Sheng Liao, San-Hsai Tow (TW)

Correspondence Address: RAYTAC CORP., P.O. BOX 108-00403, TAIPEI, TW

(73) Assignee: RAYTAC CORP., Chung Ho (TW)

(21) Appl. No.: 11/752,929

(22) Filed: May 24, 2007

(51) Int. Cl. H04Q 7/00

(52) U.S. Cl. 340/539.13; 340/539.11

(57) ABSTRACT

A mother-daughter security alarm system in which the mother unit has multiple directional antennas arranged in different directions, and a display for displaying the moving direction of the daughter unit subject to the result of a comparison procedure to compare the value of the signal received from the daughter unit through one directional antenna with the value of the signal received from the daughter unit through another directional antenna so that the user of the mother unit can search the location of the daughter unit rapidly subject to the directional indication of the display.

### BACKGROUND OF THE INVENTION

1. Field of the Invention

The present invention relates to a security alarm system and more particularly, to a mother-daughter security alarm system, which indicates the moving direction of the daughter unit through a display of the mother unit so that the user of the mother unit can search the location of the daughter unit rapidly.

2. Description of the Related Art

Abduction and kidnapping cases are frequently reported in the media. When a young child is going out with his or her parents to a public, strange or crowded place, he or she may be attracted by events and forget to follow his or her parents. The parents may be unable to find their child when become aware that their child has missed in the crowd, resulting in a family tragedy. Further, when shopping or traveling abroad, people may forget to pick up one's personal precious items (wallet, luggage, bag, overcoat, etc.), resulting in a big loss or trouble.

To eliminate the aforesaid problems, mother-daughter security alarm systems are developed. A mother-daughter security alarm system for this purpose is comprised of a mother unit to be carried by the user, and a daughter unit to be carried on the user's child or personal item. A wireless communication continues between the mother unit and the daughter unit during the use of the mother-daughter security alarm system. When the daughter unit is out of the signal receiving range of the mother unit, an alarm of the mother unit is driven to output an alarm signal. A mother-daughter security alarm system of this design simply tells the user that the daughter unit has been moved out of the signal receiving range of the mother unit. It cannot tell the user of the moving direction of the daughter unit. The user may be unable to find out of the location of the daughter unit when searching in a different direction.

### SUMMARY OF THE INVENTION

The present invention has been accomplished under the circumstances in view. It is therefore the main object of the present invention to provide a mother-daughter security alarm system, which indicates the moving direction of the daughter unit through a display in the mother unit so that the user of the mother unit can quickly search the location of the daughter unit. To achieve this and other objects of the present invention, the mother-daughter security system comprises a mother unit and a daughter unit for two-way wireless communication with the mother unit. The mother unit has multiple directional antennas arranged in different directions for receiving signal from the daughter unit, a microcontroller, and a display controlled by the microcontroller for displaying the moving direction of the daughter unit subject to the result of a comparison procedure made by the microcontroller to compare the value of the signal received from the daughter unit through one directional antenna with the value of the signal received from the daughter unit through another directional antenna. By means of the directional indication of the display, the user of the mother unit can search the location of the daughter unit rapidly.

### BRIEF DESCRIPTION OF THE DRAWINGS

FIG. 1 is a system block diagram of a mother unit for a mother-daughter security alarm system in accordance with a first embodiment of the present invention.

FIG. 2 is a system block diagram of a daughter unit for a mother-daughter security alarm system in accordance with a first embodiment of the present invention.

FIG. 3 is an operation flow chart of the mother-daughter security alarm system of the present invention.

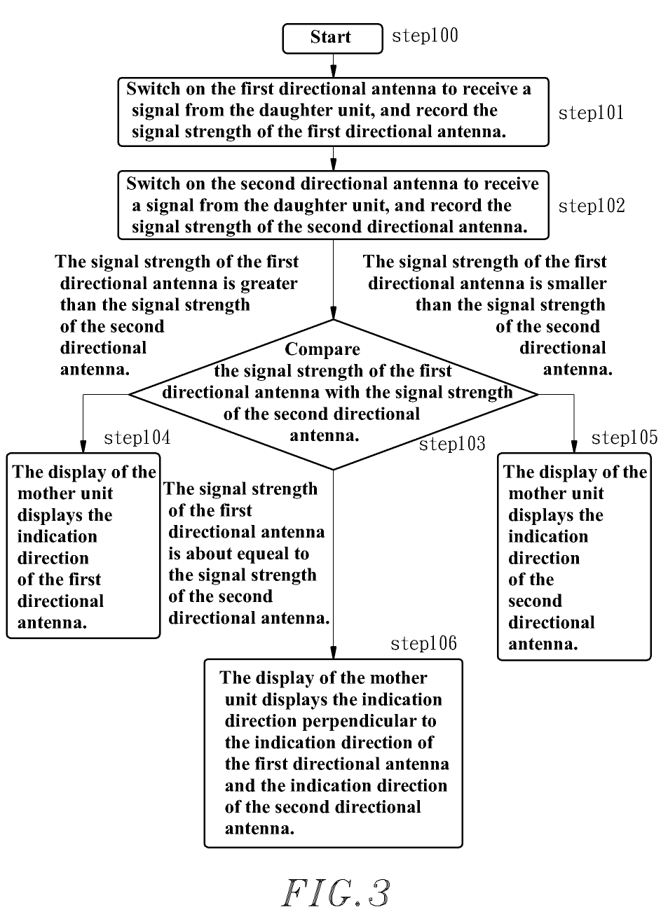

FIG. 4 is a system block diagram of a mother unit for a mother-daughter security alarm system in accordance with a second embodiment of the present invention.

FIG. 5 is a system block diagram of a daughter unit for a mother-daughter security alarm system in accordance with a second embodiment of the present invention.

### DETAILED DESCRIPTION OF THE PREFERRED EMBODIMENT

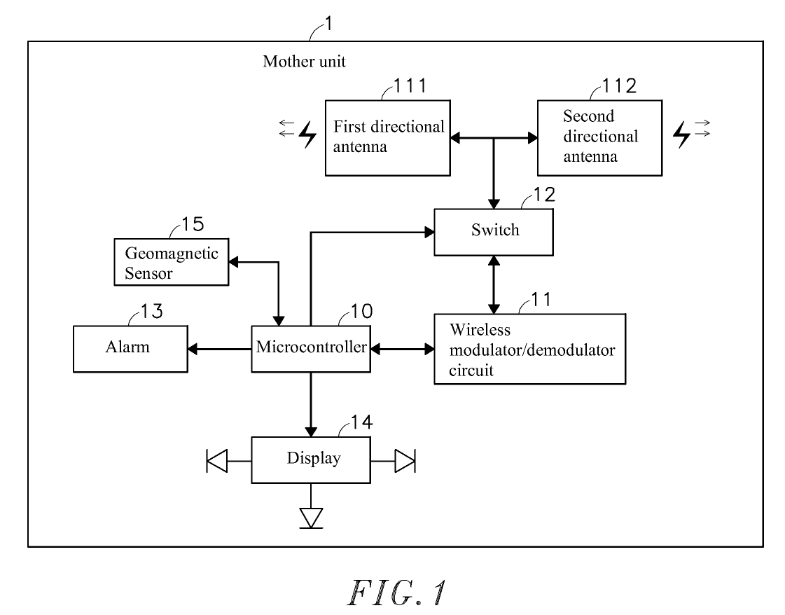

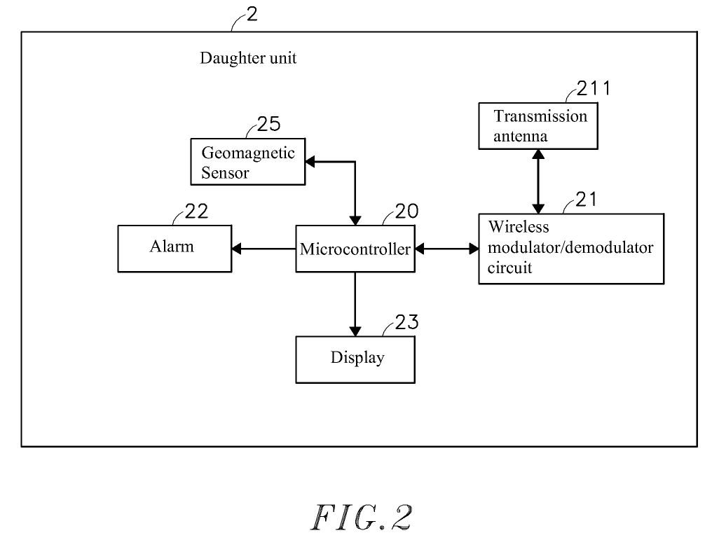

Referring to FIGS. 1 and 2, a mother-daughter security alarm system in accordance with the present invention is shown comprised of mother unit 1, and a daughter unit 2.

The mother unit 1 comprises a microcontroller 10, a wireless modulator/demodulator circuit 11 electrically connected to the microcontroller 10, a first directional antenna 111 and a second directional antenna 112 arranged in reversed directions and electrically connected to the wireless modulator/demodulator circuit 11, a switch 12 electrically connected to the microcontroller 10 and controllable by the microcontroller 10 to switch on the connection between one of the directional antennas 111 and 112 and simultaneously to switch off the connection between the other one of the directional antennas 111 and 112, an alarm 13 electrically connected to the microcontroller 10 and controllable by the microcontroller 10 to output an alarm signal, a display 14 electrically connected to the microcontroller 10 and controllable by the microcontroller 10 to output a visual directional indication signal, and a geomagnetic sensor 15 electrically connected to the microcontroller 10.

The daughter unit 2 comprises a microcontroller 20, a wireless modulator/demodulator circuit 21 electrically connected to the microcontroller 20, a transmission antenna 211 electrically connected to the wireless modulator/demodulator circuit 21, an alarm 22 electrically connected to the microcontroller 20 and controllable by the microcontroller 20 to output an alarm signal, and a display 23 electrically connected to the microcontroller 20 and controllable by the microcontroller 20 to output a visual status signal.

The aforesaid alarm 13 or 22 can be a buzzer, voice synthesizer, light emitting device or vibrator for producing a sound, voice, light or vibration signal. The display 14 or 23 can be formed of light emitting devices or a display screen.

During application, the daughter unit 2 is carried on one personal item or a baby cart, and a user carries the mother unit 1. The mother-daughter security alarm system is then operated subject to the steps:
(100) Start;
(101) The user operates the switch 12 to switch on the first directional antenna 111 for receiving a signal from the transmission antenna 211 of the daughter unit 2 so that the microcontroller 10 can record the signal strength of the signal received by the first directional antenna 111;
(102) The user operates the switch 12 again to switch on the second directional antenna 112 for receiving a signal from the transmission antenna 211 of the daughter unit 2 so that the microcontroller 10 can record the signal strength of the signal received by the second directional antenna 112;
(103) The microcontroller 10 compares the value of signal strength of the signal received by the first directional antenna 111 with the value of the signal strength of the signal received by the second directional antenna 112, and then proceeds to step (104) if the value of signal strength of the signal received by the first directional antenna 111 is greater than the value of the signal strength of the signal received by the second directional antenna 112, or proceeds to step (105) if the value of signal strength of the signal received by the first directional antenna 111 is smaller than the value of the signal strength of the signal received by the second directional antenna 112, or proceeds to step (106) if the value of signal strength of the signal received by the first directional antenna 111 is about equal to the value of the signal strength of the signal received by the second directional antenna 112;
(104) The microcontroller 10 drives the display 14 to display the indication direction of the first directional antenna 111;
(105) The microcontroller 10 drives the display 14 to display the indication direction of the second directional antenna 112;
(106) The microcontroller 10 drives the display 14 to display a vertical indication direction between the indication direction of the first directional antenna 111 and the indication direction of the second directional antenna 112.

By means of the display 14, the mother unit 1 indicates the direction and intensity of the detected signal that is indicative of the distance between the mother unit 1 and the daughter unit 2. If the daughter unit 2 is out of a signal receiving range of the mother unit 1, the alarm 13 of the mother unit 1 will be immediately driven to output a sound, voice, light or vibration alarm signal. By means of the directional indication of the display 14 subject to the aforesaid operation procedure, the user can search the location of the daughter unit 2 quickly. When the daughter unit 2 entered a set detection range relative to the user with the mother unit 1, the alarm 13 is off, and the user can keep searching the location of the daughter unit 2 within the set detection range.

By means of the geomagnetic sensor 15, the user can judge own current azimuth (determination of loxodrome, such as the south pole, the north pole, et.) for use as a reference value for searching the location of the daughter unit 2 so as to obtain the azimuth (azimuth east, azimuth south, azimuth west, azimuth north) of the daughter unit 2 quickly. Further, when searching the location of the daughter unit 2, the user can operate the switch 12 to let the wireless modulator/demodulator circuit 11 output a wireless signal through the first directional antenna 111 or the second directional antenna 112 to the daughter unit 2 subject to the control of the microcontroller 10. If the daughter unit 2 is within the detection range of the mother unit 1 at this time, the wireless signal will be received by the transmission antenna 211 of the daughter unit 2 and demodulated by the wireless modulator/demodulator circuit 21 to drive on the alarm 22 subject to the control of the microcontroller 20. By means of the warning of the sound, voice, light or vibration alarm signal of the alarm 22 of the daughter unit 2 and the directional indication of the display 14 of the mother unit 1, the user can soon find out the location of the daughter unit 2 (i.e., the location of the user's personal item or baby cart).

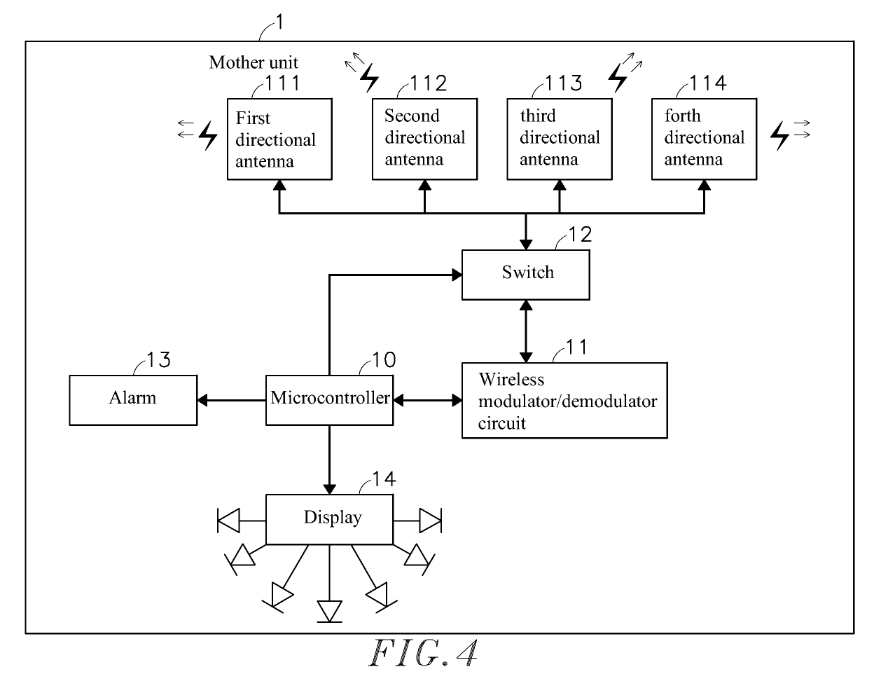

FIG. 4 is a system block diagram of an alternate form of the mother unit. This embodiment is substantially similar to the aforesaid first embodiment with the exception of the arrangement of the antennas. According to this embodiment, the mother unit 1 comprises four directional antennas, namely, a first directional antenna 111, a second directional antenna 112, a third directional antenna 113 a the fourth directional antenna 114. These four directional antennas 111˜114 are arranged in different directions to radiate greater power in a respective particular direction allowing for increased performance on transmit and receive and reduced interference from unwanted sources. The user can operate the switch 12 to switch on one of the four directional antennas 111˜114 to receive a signal from the daughter unit 2 and simultaneously to switch off the other directional antennas so that the microcontroller 10 can record the signal strength of the signal received by each of the directional antennas 111˜114 and compare the values of the signal strengths of the signals received by each two adjacent ones of the directional antennas 111˜114 for determining the moving direction of the daughter unit 2 (see also FIG. 2). In case, the values of the the signal strengths of the signals received by each two adjacent ones of the directional antennas 111˜114 are about equal, the moving direction of the daughter unit 2 is determined to be the diagonal direction in middle of the included angle made by the respective two adjacent directional antennas. By means of the directional indication by the display 14 of the mother unit 1, the user can search the location of the daughter unit 2 quickly. In actual practice, the number of the directional antennas should not be limited to 2 or 4. The number of the directional antennas determines the accuracy of the mother unit 1 in determining the moving direction of the daughter unit 2.

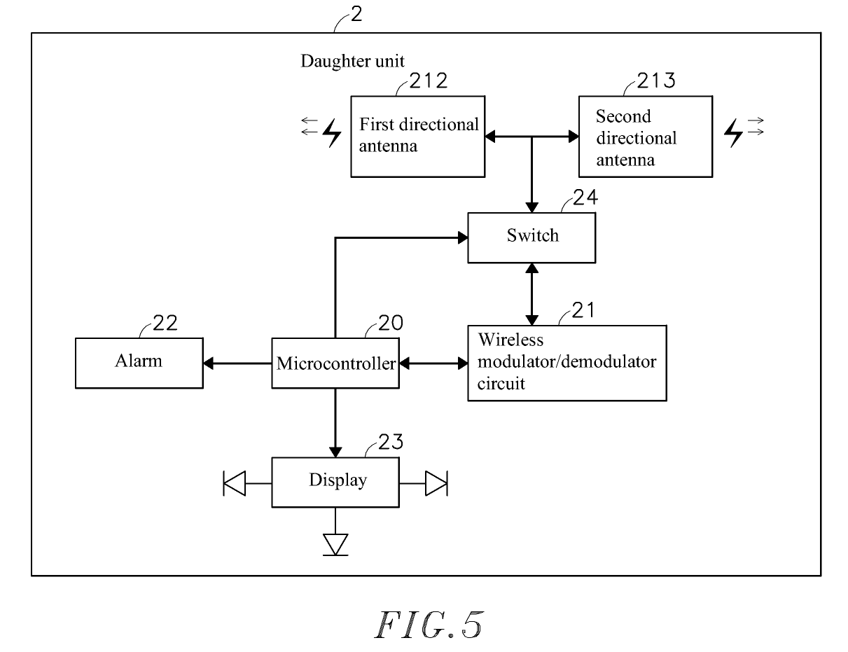

FIG. 5 is a system block diagram of an alternate form of the daughter unit. This embodiment is substantially similar to the aforesaid first embodiment with the exception of the arrangement of the antennas. According to this embodiment, the daughter unit 2 is comprised of a microcontroller 20, a wireless modulator/demodulator circuit 21, an alarm 22, a display 23, a first directional antenna 212, a second directional antenna 213 and a switch 24. The switch 24 controls the connection between the first directional antenna 212 or the second directional antenna 213 and the wireless modulator/demodulator circuit 21. The user of the daughter unit 2 can operate the switch 24 to receive a signal from the mother unit 1 (see also FIG. 1) through the first directional antenna 212 as well as through the second directional antenna 213, for enabling the microcontroller 20 to compare the value of the signal strength of the signal received by the first directional antenna 212 with the value of the signal strength of the signal received by the second directional antenna 213 and to further determine the direction of the mother unit 1 subject to the comparison result. Thus, the user of the daughter unit 2 can search the location of the mother unit 1 subject to the directional indication of the display 23.

Further, the microcontroller 20 of the daughter unit 2 has electrically connected with a geomagnetic sensor 25 (see FIG. 2). By means of the geomagnetic sensor 25, a child can judge his (her) current azimuth (determination of loxodrome, such as the south pole, the north pole, et.) for use as a reference value for searching the location of the mother unit 1 so as to obtain the azimuth (azimuth east, azimuth south, azimuth west, azimuth north) of the mother unit 1 quickly.

When compared to a similar conventional mother-daughter security alarm system, the invention uses multiple directional antennas for examining the moving direction of the daughter unit precisely. When the daughter unit 2 is out of the signal receiving range of the mother unit 1, the user of the mother unit 1 can search the location of the daughter unit 2 rapidly subject to the directional indication of the display 14 of the mother unit 1, at the same time, the geomagnetic sensors 15 and 25 provide an azimuth reference value of the daughter unit 2 and the mother unit 1 respectively.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A mother-daughter security alarm system comprising a mother unit and a daughter unit for two-way wireless communication with said mother unit, wherein:
said mother unit comprises a microcontroller, a wireless modulator/demodulator circuit electrically connected to said microcontroller of said mother unit, a first directional antenna and a second directional antenna arranged in reversed directions and electrically connected to said wireless modulator/demodulator circuit for receiving signal from said daughter unit respectively, an alarm electrically connected to said microcontroller of said mother unit and controllable by said microcontroller of said mother unit to output an alarm signal when said mother unit receives no signal from said daughter unit, and a display electrically connected to said microcontroller of said mother unit and controllable by said microcontroller to output a visual directional indication signal; and
a daughter unit, said daughter unit comprising a microcontroller, a wireless modulator/demodulator circuit electrically connected to said microcontroller of said daughter unit, and at least one antenna electrically connected to said wireless modulator/demodulator circuit of said daughter unit, said microcontroller of said daughter unit being adapted to drive said wireless modulator/demodulator circuit of said daughter unit to output a wireless signal through said at least one antenna to said mother unit;
wherein said microcontroller of said mother unit compares the value of the signal received from said daughter unit through said first directional antenna with the value of the signal received from said daughter unit through said second directional antenna, and then determines the moving direction of said daughter unit subject to the comparison result, and then drives said display of said mother unit to indicate the moving direction of said daughter unit.

2. The mother-daughter security alarm system as claimed in claim 1, wherein said mother unit further comprises a switch for switching on the connection between one of said first directional antenna and said second directional antenna and said microcontroller of said mother unit and simultaneously switching off the connection between the other of said first directional antenna and said second directional antenna and said microcontroller of said mother unit.

3. The mother-daughter security alarm system as claimed in claim 1, wherein said daughter unit further comprises an alarm electrically connected to said microcontroller of said daughter unit and controllable by said microcontroller of said daughter unit to output an alarm signal, and a display electrically connected to said microcontroller of said daughter unit and controllable by said microcontroller of said daughter unit to output a visual status signal.

4. The mother-daughter security alarm system as claimed in claim 1, wherein the alarm of said mother unit is selected from one of the devices of buzzer, voice synthesizer, light emitting device and vibrator; the display of said mother unit is selected from one of the devices of light emitting device type display and display screen type display.

5. The mother-daughter security alarm system as claimed in claim 3, wherein the alarm of said mother unit is selected from one of the devices of buzzer, voice synthesizer, light emitting device and vibrator; the display of said mother unit is selected from one of the devices of light emitting device type display and display screen type display.

6. The mother-daughter security alarm system as claimed in claim 1, wherein said microcontroller of said mother unit determines the moving direction of said daughter unit to be the direction corresponding to the direction of said first directional antenna when the value of the signal received from said daughter unit through said first directional antenna is greater than the value of the signal received from said daughter unit through said second directional antenna.

7. The mother-daughter security alarm system as claimed in claim 1, wherein said microcontroller of said mother unit determines the moving direction of said daughter unit to be the direction corresponding to the direction of said second directional antenna when the value of the signal received from said daughter unit through said first directional antenna is smaller than the value of the signal received from said daughter unit through said second directional antenna.

8. The mother-daughter security alarm system as claimed in claim 1, wherein said microcontroller of said mother unit determines the moving direction of said daughter unit to be the direction perpendicular to the direction of said first directional antenna and the direction of second directional antenna when the value of the signal received from said daughter unit through said first directional antenna is about equal to the value of the signal received from said daughter unit through said second directional antenna.

9. The mother-daughter security alarm system as claimed in claim 1, wherein the at least one antenna of said daughter unit comprises a first directional antenna and a second directional antenna arranged in reversed directions, and a switch for switching on the connection between one of the first and second directional antennas of said daughter unit and said microcontroller of said daughter unit and simultaneously switching off the connection between the other of the first and second directional antennas of said daughter unit and said microcontroller of said daughter unit.

10. The mother-daughter security alarm system as claimed in claim 1, wherein the microcontroller of one of said mother unit and said daughter unit has electrically connected thereto a geomagnetic sensor to provide an azimuth reference value.

11. A mother-daughter security alarm system comprising a mother unit and a daughter unit for two-way wireless communication with said mother unit, wherein:
said mother unit comprises a microcontroller, a wireless modulator/demodulator circuit electrically connected to said microcontroller of said mother unit, a plurality of directional antennas arranged in different directions and electrically connected to said wireless modulator/demodulator circuit for receiving signal from said daughter unit respectively, each two adjacent directional antennas of said mother unit defining a respective included angle, an alarm electrically connected to said microcontroller of said mother unit and controllable by said microcontroller of said mother unit to output an alarm signal when said mother unit receives no signal from said daughter unit, and a display electrically connected to said microcontroller of said mother unit and controllable by said microcontroller to output a visual directional indication signal; and
a daughter unit, said daughter unit comprising a microcontroller, a wireless modulator/demodulator circuit electrically connected to said microcontroller of said daughter unit, and at least one antenna electrically connected to said wireless modulator/demodulator circuit of said daughter unit, said microcontroller of said daughter unit being adapted to drive said wireless modulator/demodulator circuit of said daughter unit to output a wireless signal through said at least one antenna to said mother unit;
wherein said microcontroller of said mother unit compares the value of the signal received from said daughter unit through one of each two adjacent directional antennas with the value of the signal received from said daughter unit through the other of the same two adjacent directional antennas, and then determines the moving direction of said daughter unit subject to the comparison result, and then drives said display of said mother unit to indicate the moving direction of said daughter unit.

12. The mother-daughter security alarm system as claimed in claim 11, wherein said mother unit further comprises a switch for switching on one of said plurality of directional antennas and said microcontroller of said mother unit and simultaneously switching off the other of said plurality of directional antennas and said microcontroller of said mother unit.

13. The mother-daughter security alarm system as claimed in claim 11, wherein said daughter unit further comprises an alarm electrically connected to said microcontroller of said daughter unit and controllable by said microcontroller of said daughter unit to output an alarm signal, and a display electrically connected to said microcontroller of said daughter unit and controllable by said microcontroller of said daughter unit to output a visual status signal.

14. The mother-daughter security alarm system as claimed in claim 11, wherein the alarm of said mother unit is selected from one of the devices of buzzer, voice synthesizer, light emitting device and vibrator; the display of said mother unit is selected from one of the devices of light emitting device type display and display screen type display.

15. The mother-daughter security alarm system as claimed in claim 13, wherein the alarm of said mother unit is selected from one of the devices of buzzer, voice synthesizer, light emitting device and vibrator; the display of said mother unit is selected from one of the devices of light emitting device type display and display screen type display.

16. The mother-daughter security alarm system as claimed in claim 11, wherein said microcontroller of said mother unit determines the moving direction of said daughter unit to be the diagonal direction in the middle of the included angle made by the corresponding two adjacent directional antennas when the value of the signal received from said daughter unit through one of each two adjacent directional antennas is about equal to the value of the signal received from said daughter unit through the other of the same adjacent directional antennas.

17. The mother-daughter security alarm system as claimed in claim 11, wherein the at least one antenna of said daughter unit comprises a first directional antenna and a second directional antenna arranged in reversed directions, and a switch for switching on the connection between one of the first and second directional antennas of said daughter unit and said microcontroller of said daughter unit and simultaneously switching off the connection between the other of the first and second directional antennas of said daughter unit and said microcontroller of said daughter unit.

18. The mother-daughter security alarm system as claimed in claim 11, wherein the microcontroller of one of said mother unit and said daughter unit has electrically connected thereto a geomagnetic sensor to provide an azimuth reference value.
